(19) United States
(12) Patent Application Publication
(10) Pub. No.: US 2013/0014608 A1
(43) Pub. Date: Jan. 17, 2013

(54) Adjustable trigger for a powered tool

(71) Applicant: Brad Yang, Taichung City (TW)

(72) Inventor: Brad Yang, Taichung City (TW)

(73) Assignee: Testo Industry Corp.

(21) Appl. No.: 13/135,657

(22) Filed: Jul. 12, 2011

(51) Int. Cl. G05G 1/04

(52) U.S. Cl. 74/522

(57) ABSTRACT

A trigger has a body, two adjusting buttons, a connecting shaft, a pressing tab and a torsion spring. The body has a back, two sidewalls and two elongated slots. The adjusting buttons are slidably mounted respectively in the elongated slots and are connected to each other with the connecting shaft. The pressing tab is rotatably mounted around the connecting shaft and has a connecting segment, a first pressing segment and a second pressing segment. The first pressing segment is formed on and protrudes from the connecting segment and has a first distance to the back of the body. The second pressing segment is formed on and protrudes from the first pressing segment and has a second distance to the back of the body being different from the first distance of the first pressing segment.

### BACKGROUND OF THE INVENTION

1. Field of the Invention

The present invention relates to a trigger, and more particularly to an adjustable trigger for a powered tool, such that pneumatic or electrical tool.

2. Description of Related Art

A powered tool, such as a pneumatic or electrical tool specifically to nail gun, has a trigger pivotally mounted on a body of the tool. When the trigger is pulled, an actuating device in the tool is actuated to make the tool operating, for example shooting nails. However, the conventional trigger on a powered tool has only a single travel for actuating the actuating device, so the conventional trigger can be only applied to a single operation mode of the powered tool and is not adjustable and versatile in use.

To overcome the shortcomings, the present invention tends to provide a trigger for a powered tool to mitigate or obviate the aforementioned problems.

### SUMMARY OF THE INVENTION

The main objective of the invention is to provide a trigger that adjusting for being applied to different operation modes of a powered tool and is versatile in use. The trigger has a body, two adjusting buttons, a connecting shaft, a pressing tab and a torsion spring. The body has a back, two sidewalls and two elongated slots. The sidewalls protrude from the back. The elongated slots are defined respectively through the sidewalls and align with each other. The adjusting buttons are slidably mounted respectively in the elongated slots and are connected to each other with the connecting shaft. The pressing tab is rotatably mounted around the connecting shaft and has a connecting segment, a first pressing segment and a second pressing segment. The connecting segment is rotatably mounted around the connecting shaft. The first pressing segment is formed on and protrudes from the connecting segment and has a first distance to the back of the body. The second pressing segment is formed on and protrudes from the first pressing segment and has a second distance to the back of the body being different from the first distance of the first pressing segment. The torsion spring is mounted around the connecting shaft and has an end abutting against the pressing tab to provide a recoil force to the pressing tab.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a trigger in accordance with the present invention;

FIG. 2 is a perspective view of the trigger in FIG. 1 in a first operation mode;

FIG. 3 is a cross sectional side view of the trigger in FIG. 1 being attached to a powered tool in a first operation mode;

FIG. 4 is an operational cross sectional side view of the trigger in FIG. 3 showing the trigger being pulled to actuate an actuating device of the tool with a first travel;

FIG. 5 is a perspective view of the trigger in FIG. 1 in a second operation mode;

FIG. 6 is a cross sectional side view of the trigger in FIG. 5 being attached to a powered tool in a second operation mode; and

FIG. 7 is an operational cross sectional side view of the trigger in FIG. 6 showing the trigger being pulled to actuate an actuating device of the tool with a second travel.

### DETAILED DESCRIPTION OF PREFERRED EMBODIMENT

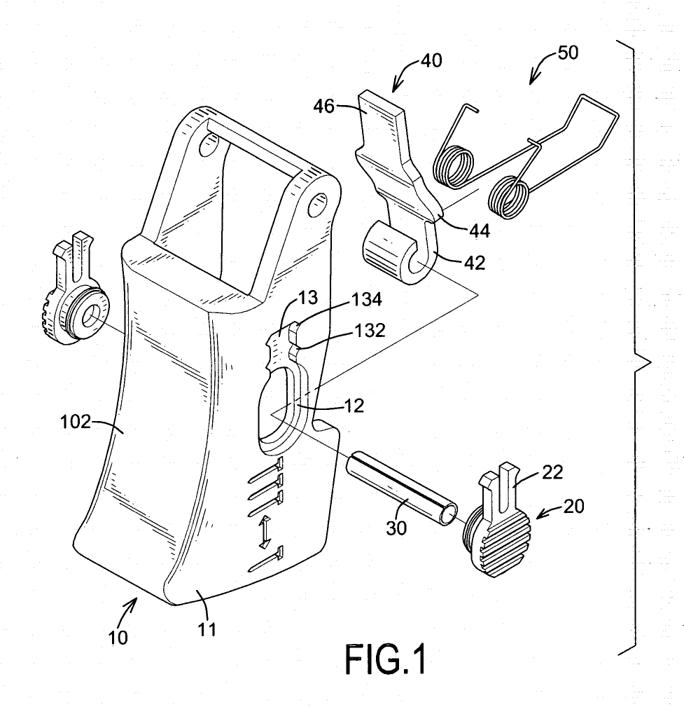

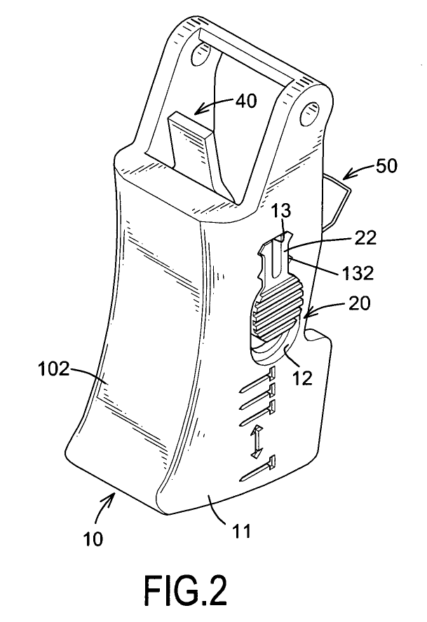

With reference to FIGS. 1 and 2, a trigger for a powered tool in accordance with the present invention comprises a body 10, two adjusting buttons 20, a connecting shaft 30, a pressing tab 40 and a torsion spring 50.

The body 10 has a back 102, two sidewalls 11, two elongated slots 12 and two engaging recesses 13. The sidewalls 11 are formed and protrude from the back 102 and are parallel with each other to make the cross section of the body 10 being U-shaped. The elongated slots 12 are defined respectively through the sidewalls 11 and align with each other. The engaging recesses 13 are defined respectively in the sidewalls 11 and communicate respectively with the elongated slots 12 in the sidewalls 11. Each engaging recess 13 has two sides and two pairs of engaging notches 132,134 defined respectively in the sides of the engaging recess 13.

The adjusting buttons 20 are slidably mounted respectively in the elongated slots 12 and are connected to each other with the connecting shaft 30. Each adjusting button 20 has a hook 22 formed on and protruding from the adjusting button 20 and selectively engaging one of the two pairs of the engaging notches 132,134 of the engaging recess 13 in a corresponding sidewall 11 on which the adjusting button 20 is mounted.

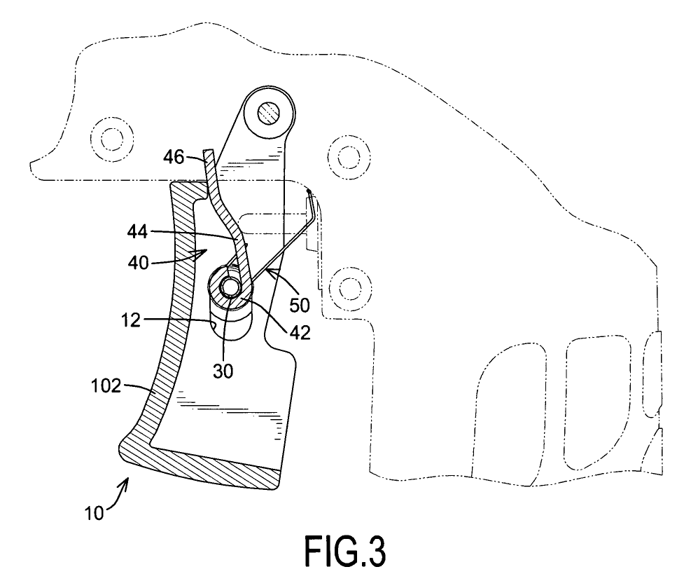

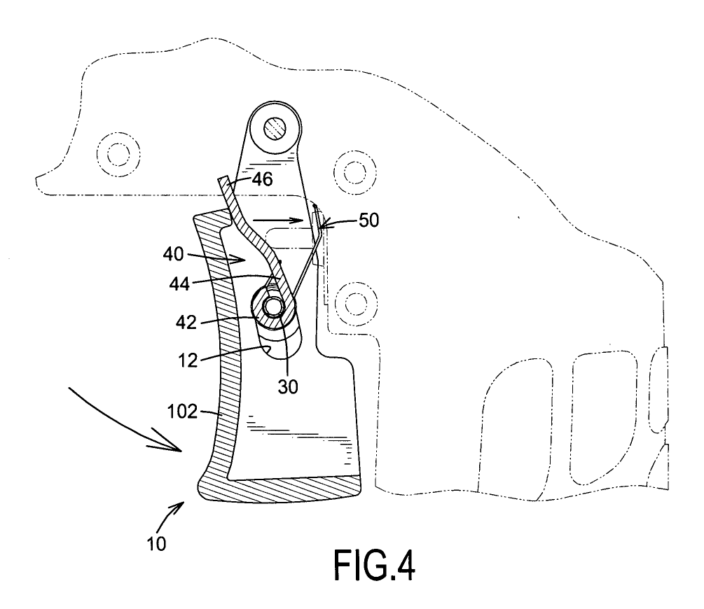

The pressing tab 40 is rotatably mounted around the connecting shaft 30 and has a connecting segment 42, a first pressing segment 44 and a second pressing segment 46. The connecting segment 42 is rotatably mounted around the connecting shaft 30. The first pressing segment 44 is formed on and protrudes from the connecting segment 42 and has a first distance to the back 102 of the body 10. The second pressing segment 46 is formed on and protrudes from the first pressing segment 46, is substantially parallel with the first pressing segment 44 and has a second distance to the back 102 of the body 11 being different from the first distance of the first pressing segment 44. In an embodiment as shown in FIGS. 3 and 4, the second distance between the second pressing segment 46 and the back 102 of the body 10 is shorter than the first distance between the first pressing segment 44 and the back 102 of the body 10. The second pressing segment 446 may abut against the top of the back 102. In an alternative embodiment, the second distance between the second pressing segment 46 and the back 102 of the body 10 is longer than the first distance between the first pressing segment 44 and the back 102 of the body 10.

The torsion spring 50 is mounted around the connecting shaft and has two ends abutting respectively against the pressing tab 40 and the tool to provide a recoil force to the pressing tab 40.

In a first operation mode, with reference to FIGS. 2 to 4, the adjusting buttons 20 are pushed to a position where the first pressing segment 44 of the pressing tab 40 corresponds to an actuating device of the powered tool. The hooks 22 on the adjusting buttons 20 respectively engage with corresponding pair of engaging notches 134 in the engaging recesses 13. Because the first distance of the first pressing segment 44 to the back 102 of the body 10 is longer than the second distance of the second pressing 46, first pressing segment 44 has a shorter distance to the actuating device than that of the second pressing segment 46. Thus, when the trigger is pulled, the first pressing segment 44 will press against the actuating device with a long travel. Consequently, the trigger may be applied to the powered tool in a repeating operation mode.

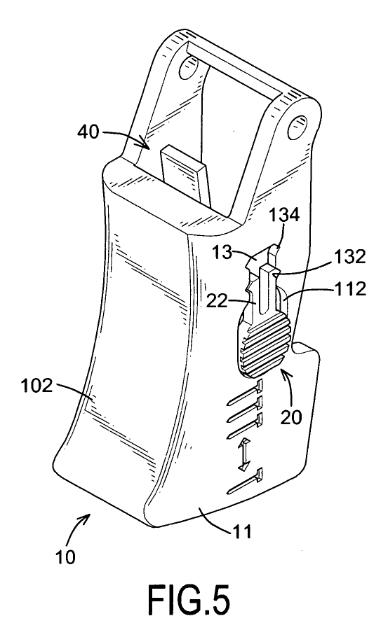

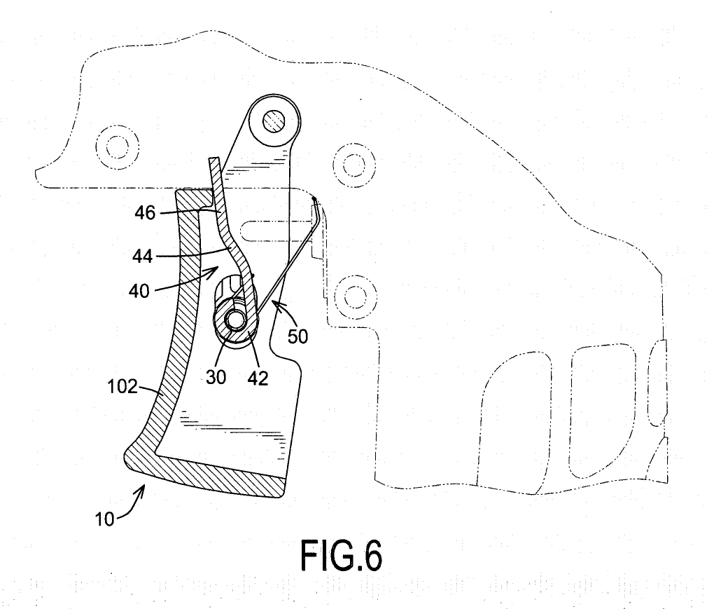

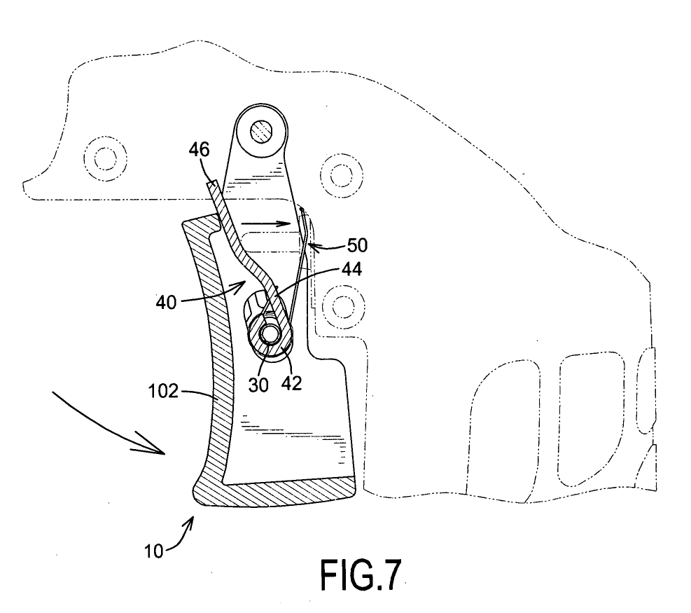

In a second operation mode, with reference to FIGS. 5 to 7, the adjusting buttons 20 are moved along the elongated slots 12 to a position where the second pressing segment 46 corresponds to the actuating device and the hooks 22 on the adjusting buttons 20 engage with the other pair of engaging notches 132. When the trigger is pulled, the second pressing segment 46 will press against and actuate the actuating device. Because the second pressing segment 46 has a shorter distance to the back 102 of the body 10, the second pressing segment 46 has a longer distance to the actuating device than the first pressing segment 44 does. The second pressing segment 46 presses against the actuating device with a short travel, such that the trigger may be applied to the powered tool in a single-shoot operation mode.

Accordingly, the operation modes of the trigger applying for a powered tool can be easily adjusted and changed by moving the adjusting buttons 20 along the slots 12, so the trigger is adjustable and versatile in use. With the engagement between the hooks 22 and the engaging notches 132,134, the adjusting buttons 20 can be held securely in a specific desired operation mode.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A trigger for a powered tool comprising:
a body having
a back;
two sidewalls protruding from the back; and
two elongated slots defined respectively through the sidewalls and aligning with each other;
two adjusting buttons slidably mounted respectively in the elongated slots and connected to each other with a connecting shaft;
a pressing tab rotatably mounted around the connecting shaft and having
a connecting segment rotatably mounted around the connecting shaft;
a first pressing segment formed on and protruding from the connecting segment and having a first distance to the back of the body; and
a second pressing segment formed on and protruding from the first pressing segment and having a second distance to the back of the body being different from the first distance of the first pressing segment; and
a torsion spring mounted around the connecting shaft and having an end abutting against the pressing tab to provide a recoil force to the pressing tab.

2. The scissors as claimed in claim 1, wherein the second distance between the second pressing segment and the back of the body is shorter than the first distance between the first pressing segment and the back of the body.

3. The scissors as claimed in claim 2, wherein
each sidewall of the body further has an engaging recess communicating with the elongated slot in the sidewall and comprising
two sides;
two pairs of engaging notches defined respectively in the sides of the engaging recess; and
each adjusting button further has a hook formed on and protruding from the adjusting button and selectively engaging one of the two pairs of the engaging notches of the engaging recess in a corresponding sidewall on which the adjusting button is mounted.

4. The scissors as claimed in claim 1, wherein
each sidewall of the body further has an engaging recess communicating with the elongated slot in the sidewall and comprising
two sides;
two pairs of engaging notches defined respectively in the sides of the engaging recess; and
each adjusting button further has a hook formed on and protruding from the adjusting button and selectively engaging one of the two pairs of the engaging notches of the engaging recess in a corresponding sidewall on which the adjusting button is mounted.
